(19) United States
(12) Patent Application Publication
(10) Pub. No.: US 2019/0021241 A1
(43) Pub. Date: Jan. 24, 2019

(54) ADJUSTABLE TREE GUARD DEVICE

(71) Applicant: Mark STREISFELD, Boca Raton, FL (US)

(72) Inventor: Mark STREISFELD, Boca Raton, FL (US)

(21) Appl. No.: 15/902,565

(22) Filed: Feb. 22, 2018

Related U.S. Application Data
(60) Provisional application No. 62/533,766, filed on Jul. 18, 2017.

(51) Int. Cl. A01G 13/10; A01G 13/02

(52) U.S. Cl. CPC A01G 13/105; A01G 13/0237

(57) ABSTRACT

A guard device configured to be disposed concentrically about a generally cylindrical structure, including: a plurality of adjoined panels collectively forming an annular ring structure that is configured to be disposed concentrically about the generally cylindrical structure; an attachment mechanism disposed at one end of one or more of the plurality of adjoined panels that is configured to secure the annular ring structure about the generally cylindrical structure; and one or more adjustment mechanisms disposed along edges of the plurality of adjoined panels that are configured to adjustably couple the plurality of panels together to form the annular ring structure. Each of the adjustment mechanisms includes a slot defining detent positions disposed along an edge of one panel and a mating peg structure disposed along an opposed edge of an adjacent panel, wherein the peg structure is configured to be translated between the detent positions defined by the slot.

### CROSS-REFERENCE TO RELATED APPLICATION

The present patent application/patent claims the benefit of priority of co-pending U.S. Provisional Patent Application No. 62/533,766, filed on Jul. 18, 2017, and entitled “TREE GUARD DEVICE,” the contents of which are incorporated in full by reference herein.

### FIELD OF THE INVENTION

The present invention relates generally to an adjustable tree guard device that is configured to be selectively disposed around a tree trunk, pole, or the like several feet from the ground, thereby keeping pests, such as squirrels, iguanas, rats, or the like, from traveling up the tree trunk, pole, or the like and potentially onto an adjacent structure, such as a house, building, or the like. This adjustable tree guard device may be used in a wide variety of similar applications for a wide variety of similar purposes.

### BACKGROUND OF THE INVENTION

In most geographical locations, pests are a problem and often undesirably scale tree trunks, posts, and the like to gain access to houses, buildings, and the like, and especially the roofs of such structures, where they gain access to a soffit or attic, for example. Damage typically results. A variety of conventional devices exist for blocking this pest conduit. Most of these conventional devices consist of a concentric plastic shield or the like that is secured around a tree trunk, post, or the like using simple strap, string, wire, nails, adhesive tape, or the like. These conventional devices typically suffer from difficult operation, inadequate adjustability, poor fit, a lack of durability, etc.

Thus, what is still needed in the art is an improved tree guard device that is easy to use, fully adjustable, fits well, and is durable. In various exemplary embodiments, the present invention provides such an improved tree guard device.

### BRIEF SUMMARY OF THE INVENTION

In various exemplary embodiments, the present invention provides an adjustable tree guard device that is configured to be selectively disposed around a tree trunk, pole, or the like several feet from the ground, thereby keeping pests, such as squirrels, iguanas, rats, or the like, from traveling up the tree trunk, pole, or the like and potentially onto an adjacent structure, such as a house, building, or the like. This adjustable tree guard device may be used in a wide variety of similar applications for a wide variety of similar purposes.

In one exemplary embodiment, the present invention provides a guard device configured to be disposed concentrically about a generally cylindrical structure, including: a plurality of adjoined panels collectively forming an annular ring structure that is configured to be disposed concentrically about the generally cylindrical structure; an attachment mechanism disposed at one end of one or more of the plurality of adjoined panels that is configured to secure the annular ring structure about the generally cylindrical structure; and one or more adjustment mechanisms disposed along edges of the plurality of adjoined panels that are configured to adjustably couple the plurality of panels together to form the annular ring structure. Each of the plurality of adjoined panels includes a truncated wedge-shaped structure. Each of the plurality of adjoined panels is manufactured from one of a rigid material and a semi-rigid material. Optionally, the plurality of adjoined panels includes at least four adjoined panels. Each of the attachment mechanisms includes a loop structure defining a port protruding from a surface of the corresponding panel adjacent to an inside end of the corresponding panel configured to receive one of a nylon strap (optionally locked), string, a wire, a nail, and adhesive tape. Each port is aligned one of parallel to and perpendicular to a surface of the generally cylindrical structure. Each of the attachment mechanisms includes a wedge structure protruding from a surface of the corresponding panel adjacent to an inside end of the corresponding panel configured to brace the panel against a surface of the generally cylindrical structure. Each of the adjustment mechanisms includes a slot defining detent positions disposed along an edge of one panel and a mating peg structure disposed along an opposed edge of an adjacent panel, wherein the peg structure is configured to be translated between the detent positions defined by the slot such that the positioning and orientation of the one panel relative to the adjacent panel can be adjusted. Optionally, the peg structures are removable from the corresponding panels. The annular ring structure defines a central hole in which the generally cylindrical structure is disposed, and wherein each of the plurality of adjoined panels has a generally downward slope such that the annular ring structure forms a generally downward-facing conical structure disposed about the generally cylindrical structure.

In another exemplary embodiment, the present invention provides a method for providing a guard device configured to be disposed concentrically about a generally cylindrical structure, including: providing a plurality of adjoined panels collectively forming an annular ring structure that is configured to be disposed concentrically about the generally cylindrical structure; providing an attachment mechanism disposed at one end of one or more of the plurality of adjoined panels that is configured to secure the annular ring structure about the generally cylindrical structure; and providing one or more adjustment mechanisms disposed along edges of the plurality of adjoined panels that are configured to adjustably couple the plurality of panels together to form the annular ring structure. Each of the plurality of adjoined panels includes a truncated wedge-shaped structure. Each of the plurality of adjoined panels is manufactured from one of a rigid material and a semi-rigid material. Optionally, the plurality of adjoined panels includes at least four adjoined panels. Each of the attachment mechanisms includes a loop structure defining a port protruding from a surface of the corresponding panel adjacent to an inside end of the corresponding panel configured to receive one of a nylon strap (optionally locked), string, a wire, a nail, and adhesive tape. Each port is aligned one of parallel to and perpendicular to a surface of the generally cylindrical structure. Each of the attachment mechanisms includes a wedge structure protruding from a surface of the corresponding panel adjacent to an inside end of the corresponding panel configured to brace the panel against a surface of the generally cylindrical structure. Each of the adjustment mechanisms includes a slot defining detent positions disposed along an edge of one panel and a mating peg structure disposed along an opposed edge of an adjacent panel, wherein the peg structure is configured to be translated between the detent positions defined by the slot such that the positioning and orientation of the one panel relative to the adjacent panel can be adjusted. Optionally, the peg structures are removable from the corresponding panels. The annular ring structure defines a central hole in which the generally cylindrical structure is disposed, and wherein each of the plurality of adjoined panels has a generally downward slope such that the annular ring structure forms a generally downward-facing conical structure disposed about the generally cylindrical structure.

### BRIEF DESCRIPTION OF THE DRAWINGS

The present invention is illustrated and described herein with reference to the various drawings, in which like reference numbers are used to denote like device components/method steps, as appropriate, and in which:

FIG. 1 is a perspective view of one exemplary embodiment of the tree guard device of the present invention in use around a tree;

FIG. 2 is a series of perspective and side planar views of a plurality of panels of one exemplary embodiment of the tree guard device of the present invention in an assembled state;

FIG. 3 is a series of perspective views of a plurality of panels of one exemplary embodiment of the tree guard device of the present invention in an unassembled state and an assembled state;

FIG. 4 is a perspective view of one panel of one exemplary embodiment of the tree guard device of the present invention in an unassembled state;

FIG. 5 is a perspective view of one panel of one exemplary embodiment of the tree guard device of the present invention in an assembled state;

FIG. 6 is a perspective view of one exemplary embodiment of the tree guard device of the present invention in use being assembled around a tree and stopping the ascent of an iguana;

FIG. 7 is a perspective view of one exemplary embodiment of the tree guard device of the present invention partially assembled with an associated nylon strap holding the panels together; and

FIG. 8 is a perspective view of one exemplary embodiment of the tree guard device of the present invention in use around a tree several feet from the ground.

### DETAILED DESCRIPTION OF THE INVENTION

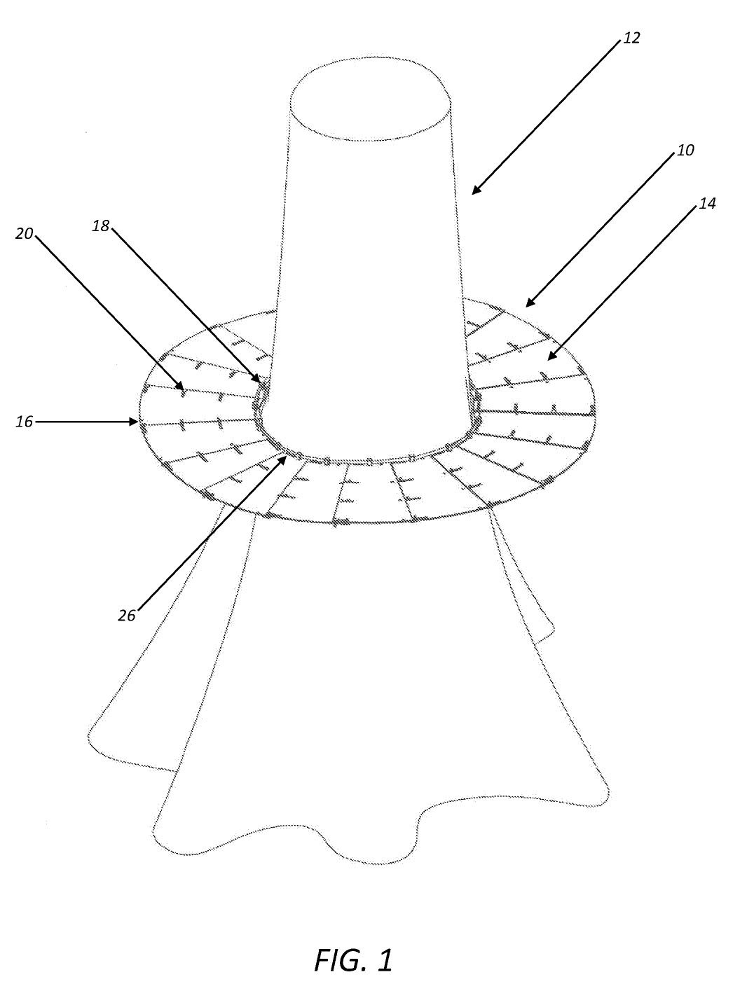

Referring now specifically to FIG. 1, in one exemplary embodiment, the present invention provides a guard device 10 configured to be disposed concentrically about a generally cylindrical structure 12, such as a tree, pole, or the like several feet from the ground, thereby keeping pests, such as squirrels, iguanas, rats, or the like, from traveling up the tree trunk, pole, or the like and potentially onto an adjacent structure, such as a house, building, or the like. This adjustable tree guard device may be used in a wide variety of similar applications for a wide variety of similar purposes. It is very effective against cats, raccoons, rats, mice, chipmunks, voles, foxes, opossums, lizards, frogs, etc. The guard device 10 includes a plurality of adjoined panels 14 collectively forming a fan-like annular ring structure 16 that is configured to be disposed concentrically about the generally cylindrical structure 12. An attachment mechanism 18 is disposed at one end of one or more of the plurality of adjoined panels 14 that is configured to secure the annular ring structure 16 about the generally cylindrical structure 12. One or more adjustment mechanisms 20 are disposed along edges of the plurality of adjoined panels 14 that are configured to adjustably couple the plurality of panels 14 together to form the annular ring structure 16.

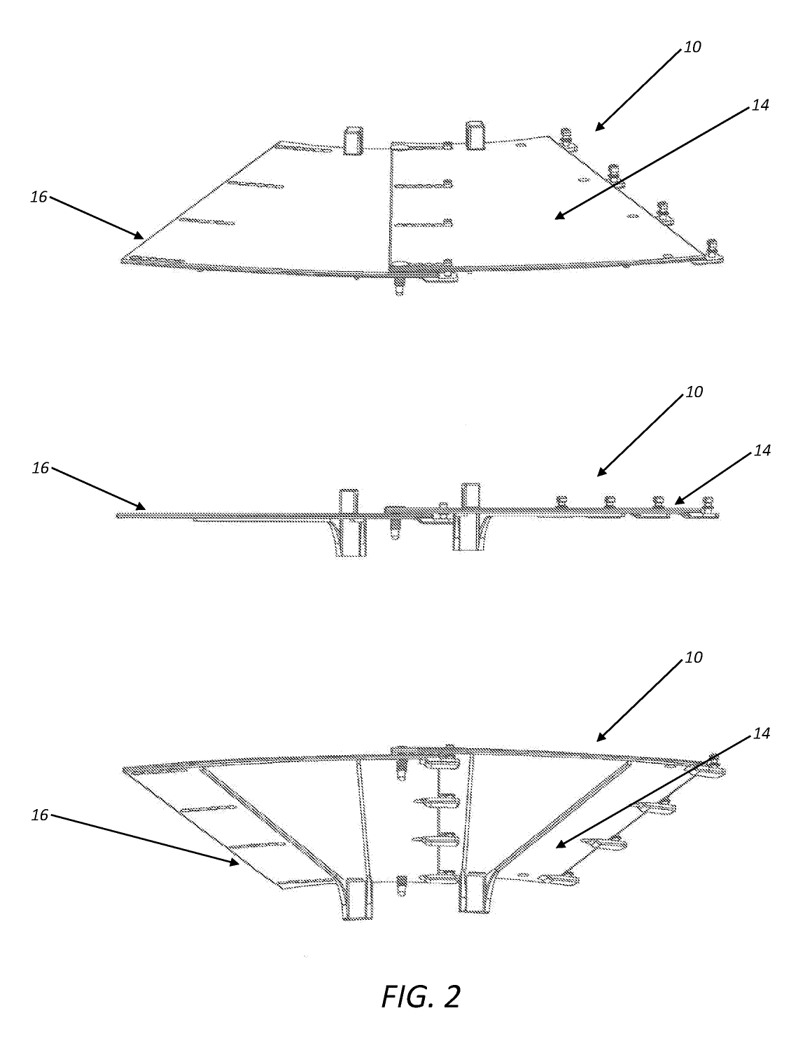

Referring now specifically to FIG. 2, in one exemplary embodiment, each of the plurality of adjoined panels 14 is a truncated wedge-shaped structure, although it will be readily apparent to those of ordinary skill in the art that other suitable shapes may be utilized equally. By way of example only, each panel 14 may be about 12 inches long by about 4 inches wide at the tip by about 8 inches wide at the base. Both the tip edge and the base edge may be curved, if desired, such that the assembled annular structure 16 approximates a circle. Different size ranges can be used to accommodate generally different sized trees, poles, or the like. Each of the plurality of adjoined panels 14 is manufactured from one of a rigid material and a semi-rigid material, such as a plastic material that is durable and weather resistant. Optionally, the plurality of adjoined panels 14 includes at least four adjoined panels 14, although more are typically used.

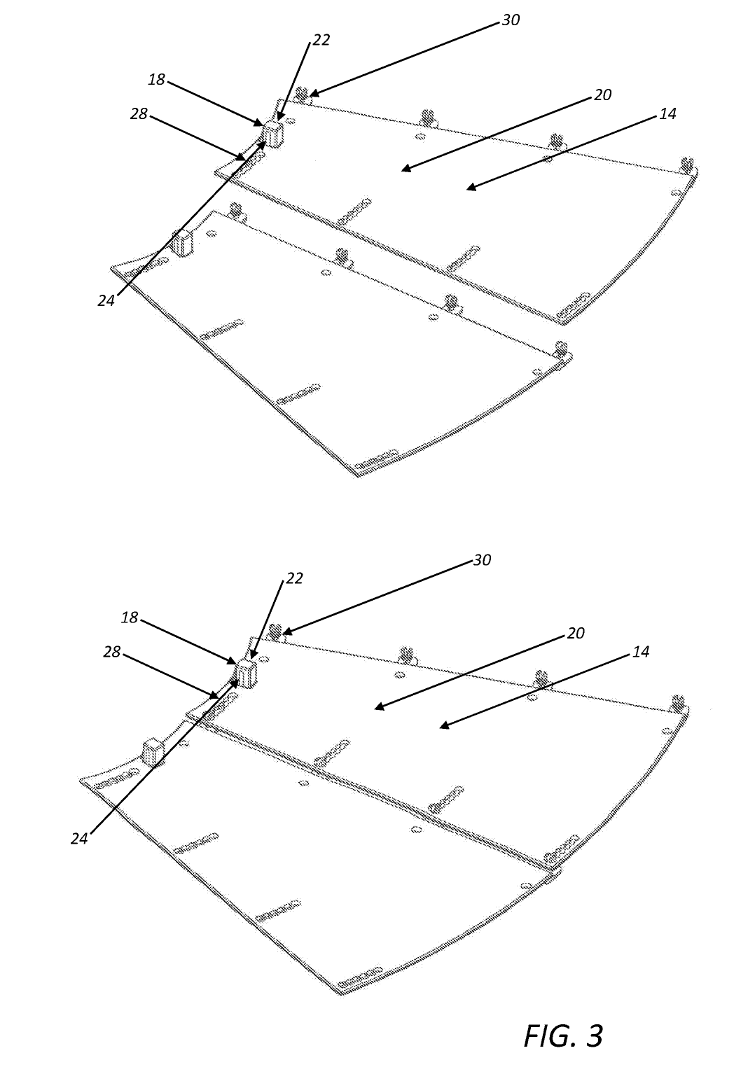

Referring now specifically to FIGS. 3-5, in one exemplary embodiment, each of the attachment mechanisms 18 includes a loop structure 22 defining a port 24 protruding from a surface of the corresponding panel 14 adjacent to an inside end of the corresponding panel 14. This loop structure 22 may be substantially rigid or substantially flexible, provided that it is configured to receive one of a nylon strap 26 (FIG. 1) (optionally locked), a string, a wire, a nail, an adhesive tape, or the like. For example, a nylon strap 26 may be threaded through the plurality of loop structures 22 and tied off about the generally cylindrical structure 12 (FIG. 1) to secure the annular structure 16 (FIGS. 1 and 2) about the generally cylindrical structure 12. Each port 24 is aligned one of parallel to and perpendicular to a surface of the generally cylindrical structure 12. The parallel ports 24 are used with a nylon strap 26 and the perpendicular ports are used with nails, for example.

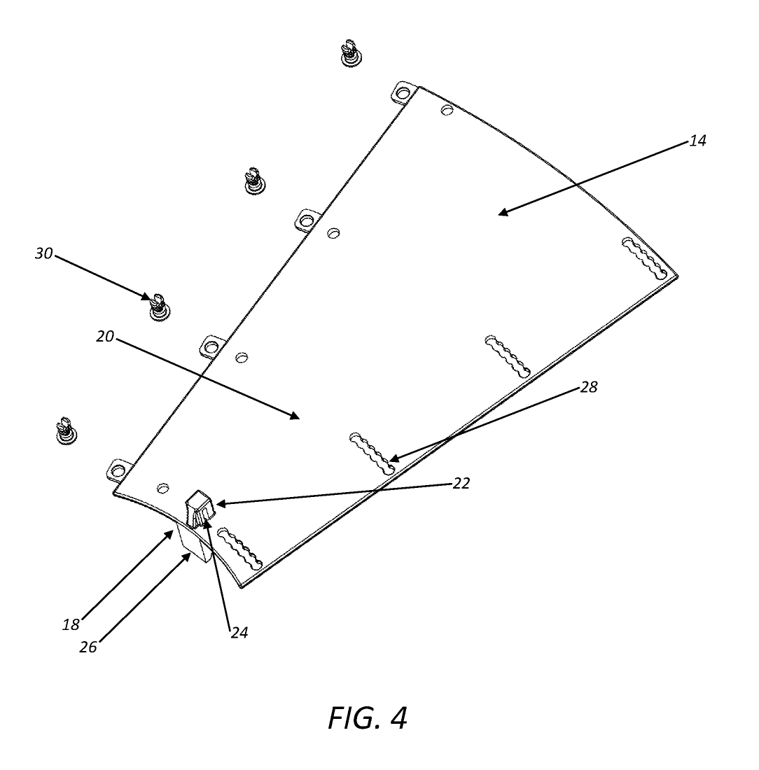

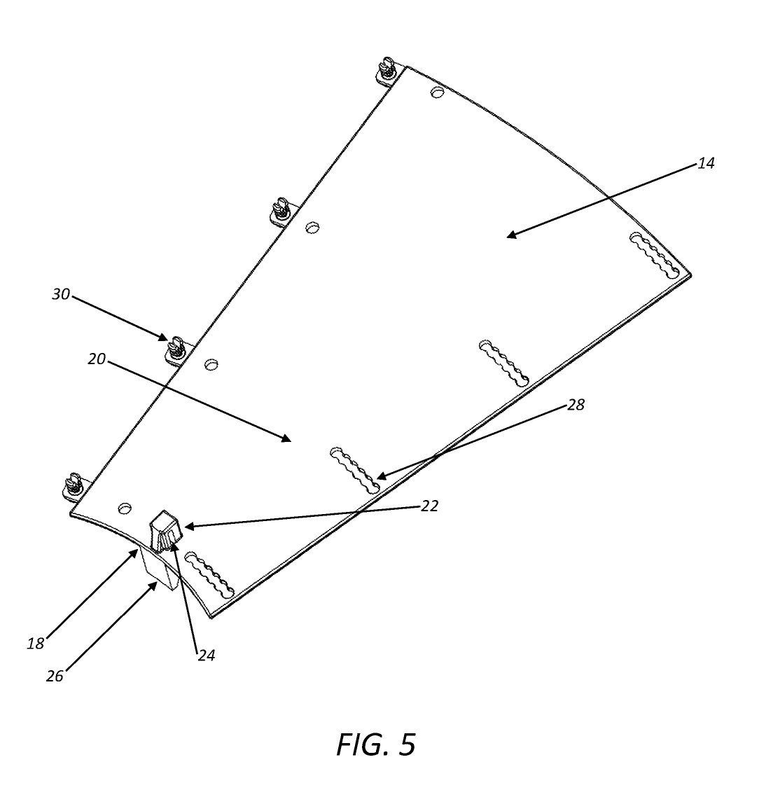

Each of the attachment mechanisms 18 also optionally includes a wedge structure 26 (FIGS. 4 and 5) protruding from a surface of the corresponding panel 14 adjacent to an inside end of the corresponding panel 14 configured to brace the panel 14 against a surface of the generally cylindrical structure 12. Preferably, this wedge structure 26 is disposed opposite the corresponding loop structure 22.

Each of the adjustment mechanisms 20 includes a slot 28 defining detent positions disposed along an edge of one panel 14 and a mating peg structure 30 disposed along an opposed edge of an adjacent panel 14, wherein the peg structure 30 is configured to be translated between the detent positions defined by the slot 28 such that the positioning and orientation of the one panel 14 relative to the adjacent panel 14 can be adjusted. Optionally, the peg structures 30 are removable from the corresponding panels 14. In the exemplary embodiment illustrated, each of the peg structures 30 utilizes a split end, such that the peg structure 30 can be “snapped” through the corresponding slot 28 while resisting backing out. The peg structure 30 can also be “snapped” between the detents of the corresponding slot 28. In the exemplary embodiment illustrated, each of the panels 14 utilizes four adjustment mechanisms 20, although fewer or more could be used with each panel. Preferably, each of the peg structures 30 is attached to the corresponding panel 14 via a swivel attachment or the like, such that additional adjustability is provided.

FIG. 4 is a perspective view of one panel 14 of one exemplary embodiment of the guard device 10 of the present invention in an unassembled state. FIG. 5 is a perspective view of one panel 14 of one exemplary embodiment of the guard device 10 of the present invention in an assembled state.

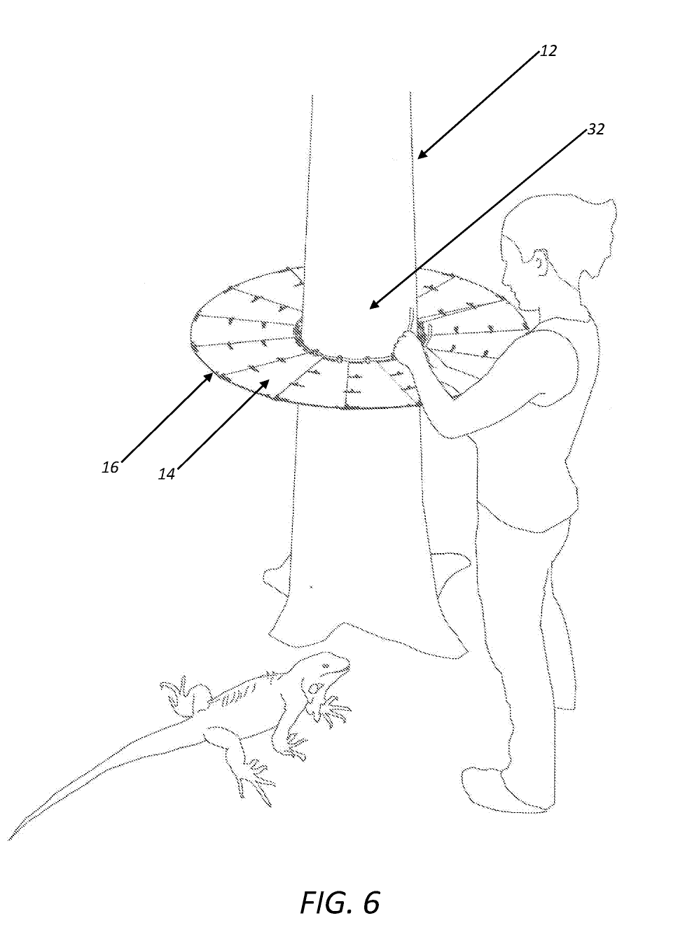

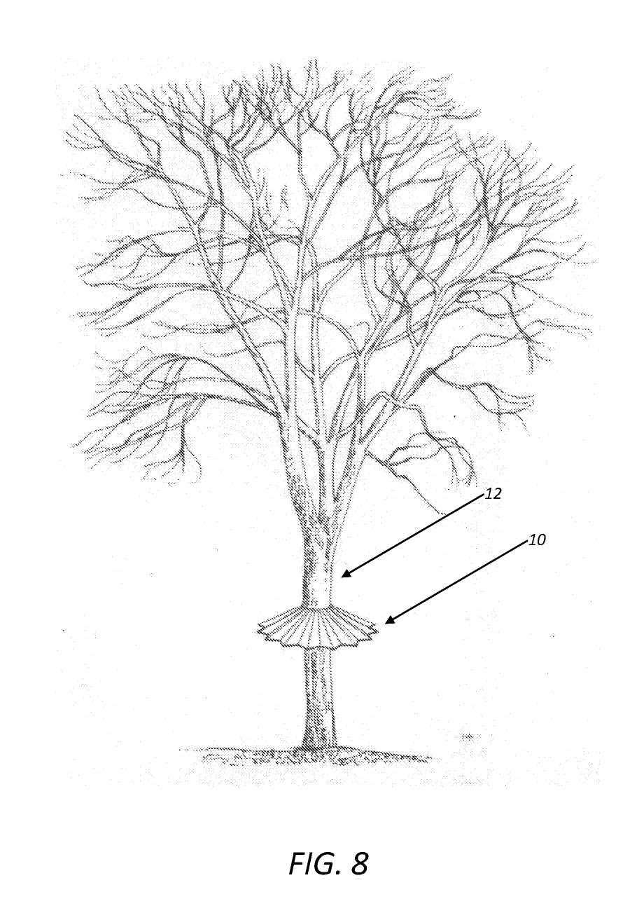

Referring now specifically to FIG. 6, in one exemplary embodiment, the annular ring structure 16 defines a central hole 32 in which the generally cylindrical structure 12 is disposed. Each of the plurality of adjoined panels 14 ultimately has a generally downward slope such that the annular ring structure 16 forms a generally downward-facing conical structure disposed about the generally cylindrical structure 12. This is illustrated more clearly in FIG. 8.

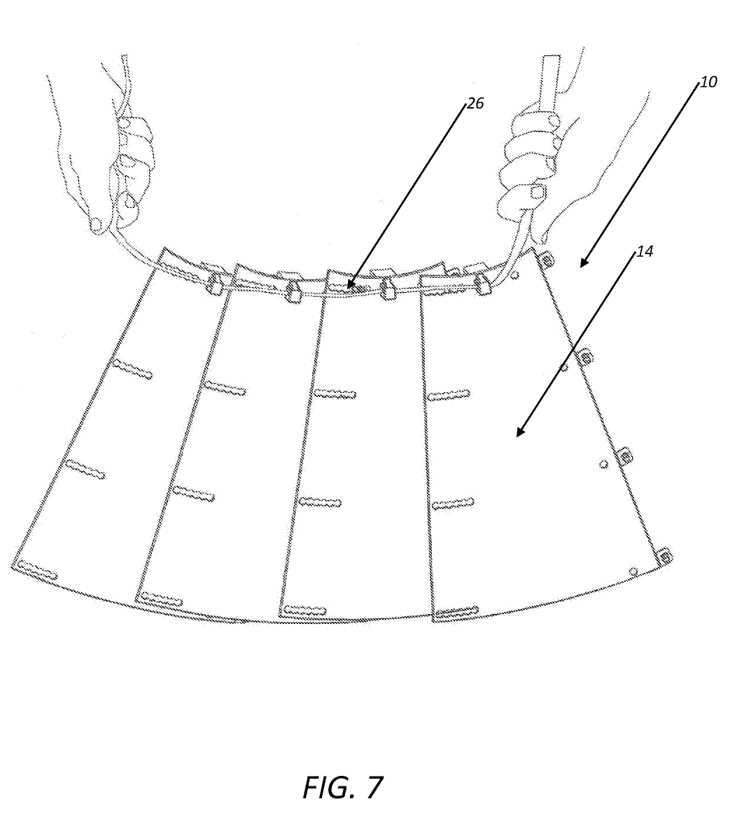

Finally, FIG. 7 is a perspective view of one exemplary embodiment of the tree guard device 10 of the present invention partially assembled with an associated nylon strap 26 holding the panels 14 together.

Although the present invention is illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims for all purposes.

What is claimed is:

1. A guard device configured to be disposed concentrically about a generally cylindrical structure, comprising:
a plurality of adjoined panels collectively forming an annular ring structure that is configured to be disposed concentrically about the generally cylindrical structure;
an attachment mechanism disposed at one end of one or more of the plurality of adjoined panels that is configured to secure the annular ring structure about the generally cylindrical structure; and
one or more adjustment mechanisms disposed along edges of the plurality of adjoined panels that are configured to adjustably couple the plurality of panels together to form the annular ring structure.

2. The guard device of claim 1, wherein each of the plurality of adjoined panels comprises a truncated wedge-shaped structure.

3. The guard device of claim 1, wherein each of the plurality of adjoined panels is manufactured from one of a rigid material and a semi-rigid material.

4. The guard device of claim 1, wherein the plurality of adjoined panels comprises at least four adjoined panels.

5. The guard device of claim 1, wherein each of the attachment mechanisms comprises a loop structure defining a port protruding from a surface of the corresponding panel adjacent to an inside end of the corresponding panel configured to receive one of a strap, a string, a wire, a nail, and adhesive tape.

6. The guard device of claim 5, wherein each port is aligned one of parallel to and perpendicular to a surface of the generally cylindrical structure.

7. The guard device of claim 1, wherein each of the attachment mechanisms comprises a wedge structure protruding from a surface of the corresponding panel adjacent to an inside end of the corresponding panel configured to brace the panel against a surface of the generally cylindrical structure.

8. The guard device of claim 1, wherein each of the adjustment mechanisms comprises a slot defining detent positions disposed along an edge of one panel and a mating peg structure disposed along an opposed edge of an adjacent panel, wherein the peg structure is configured to be translated between the detent positions defined by the slot such that the positioning and orientation of the one panel relative to the adjacent panel can be adjusted.

9. The guard device of claim 8, wherein the peg structures are removable from the corresponding panels.

10. The guard device of claim 1, wherein the annular ring structure defines a central hole in which the generally cylindrical structure is disposed, and wherein each of the plurality of adjoined panels has a generally downward slope such that the annular ring structure forms a generally downward-facing conical structure disposed about the generally cylindrical structure.

11. A method for providing a guard device configured to be disposed concentrically about a generally cylindrical structure, comprising:
providing a plurality of adjoined panels collectively forming an annular ring structure that is configured to be disposed concentrically about the generally cylindrical structure;
providing an attachment mechanism disposed at one end of one or more of the plurality of adjoined panels that is configured to secure the annular ring structure about the generally cylindrical structure; and
providing one or more adjustment mechanisms disposed along edges of the plurality of adjoined panels that are configured to adjustably couple the plurality of panels together to form the annular ring structure.

12. The method of claim 11, wherein each of the plurality of adjoined panels comprises a truncated wedge-shaped structure.

13. The method of claim 11, wherein each of the plurality of adjoined panels is manufactured from one of a rigid material and a semi-rigid material.

14. The method of claim 11, wherein the plurality of adjoined panels comprises at least four adjoined panels.

15. The method of claim 11, wherein each of the attachment mechanisms comprises a loop structure defining a port protruding from a surface of the corresponding panel adjacent to an inside end of the corresponding panel configured to receive one of a strap, a string, a wire, a nail, and adhesive tape.

16. The method of claim 15, wherein each port is aligned one of parallel to and perpendicular to a surface of the generally cylindrical structure.

17. The method of claim 11, wherein each of the attachment mechanisms comprises a wedge structure protruding from a surface of the corresponding panel adjacent to an inside end of the corresponding panel configured to brace the panel against a surface of the generally cylindrical structure.

18. The method of claim 11, wherein each of the adjustment mechanisms comprises a slot defining detent positions disposed along an edge of one panel and a mating peg structure disposed along an opposed edge of an adjacent panel, wherein the peg structure is configured to be translated between the detent positions defined by the slot such that the positioning and orientation of the one panel relative to the adjacent panel can be adjusted.

19. The method of claim 18, wherein the peg structures are removable from the corresponding panels.

20. The method of claim 11, wherein the annular ring structure defines a central hole in which the generally cylindrical structure is disposed, and wherein each of the plurality of adjoined panels has a generally downward slope such that the annular ring structure forms a generally downward-facing conical structure disposed about the generally cylindrical structure.
